(19) United States
(12) Patent Application Publication
(10) Pub. No.: US 2009/0300268 A1
(43) Pub. Date: Dec. 3, 2009

(54) INFORMATION PROCESSING APPARATUS AND METHOD OF RECORDING USING START DATE THEREOF

(75) Inventors: Toru Hanada, Ome-shi (JP); Hideaki Andou, Ome-shi (JP); Mayumi Maeda, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/333,993

(22) Filed: Dec. 12, 2008

(30) Foreign Application Priority Data
May 29, 2008 (JP) 2008-141375

(51) Int. Cl. G06F 12/16; G06F 12/00

(52) U.S. Cl. 711/102; 711/E12.001; 711/E12.091

(57) ABSTRACT

According to an aspect of the present invention, there is provided an information processing apparatus including: a date generating module configured to generate date information in a real time; a nonvolatile recording module configured to record the date information in a given area; and a recording control module configured to access to the given area when specific software is started, wherein the recording control module is configured to record present date information generated by the date generating module in the given area when the date information is not recorded in the given area.

### CROSS-REFERENCE TO RELATED APPLICATIONS

This application is based upon and claims the benefit of priority from Japanese Patent Application No. 2008-141375, filed on May 29, 2008, the entire contents of which are incorporated herein by reference.

### BACKGROUND

1. Field

An aspect of the present invention relates to an information processing apparatus and a method of recording a using start date thereof, and more particularly to an information processing apparatus for automatically recording a date that a user first uses the information processing apparatus after purchasing the apparatus and a method of recording a using start date thereof in order to confirm a service guarantee period of the apparatus.

2. Description of the Related Art

In general, a supplier (a manufacturer or a distributor) for an information processing apparatus such as a personal computer gives a guarantee determined by a written guarantee for a predetermined term of guarantee after a selling date of the apparatus. When something is wrong with quality of the apparatus without any abnormal operation within the term of guarantee, the supplier of the apparatus generally carries out a free repair or free exchange of the apparatus.

When purchasing the apparatus, a consumer receives, from a supplier such as a dealer, a certificate for proving a selling date (a written guarantee or a receipt in which the selling date is written). When something is wrong with quality of the apparatus without any abnormal operation within the term of guarantee, the consumer presents the certificate for the selling date to the supplier to have the apparatus repaired or exchanged for free.

However, the consumer sometimes loses the certificate. In this case, it is impossible to prove that a date for generation of a failure of the apparatus is included in the term of guarantee. For this reason, it is impossible to have the apparatus repaired or exchanged for free by right and the consumer may suffer from a disadvantage in some cases.

On the other hand, in many cases in which priority is given to a profit of the customer and the customer (consumer) loses the certificate, a selling date applied by the customer is trusted and the free repair or free exchange is carried out if the selling date corresponds to the term of guarantee. In this case, it is impossible to perfectly eliminate a customer applying a selling date falsely as if it corresponds to the term of guarantee though the term of guarantee expires. Consequently, the supplier side may suffer from a disadvantage in some cases.

In order to solve the problems, JP-A-2000-152287 discloses a technique for storing a date that a consumer first uses a product after purchasing it in a memory provided in the product. More specifically, there is disclosed a technique for storing date information included in a received broadcast signal in a nonvolatile memory when a consumer having purchased an electronic apparatus such as a television receiver first turns ON a power switch.

Referring to the technique disclosed in JP-A-2000-152287, a specific operating portion such as a power switch is operated by a user to give access to a specific area of a nonvolatile memory, and it is determined that use is not carried out first time if date information has already been recorded in the area, while it is determined that the use is first carried out and date information received at that time is recorded if the date information is not recorded in the area.

According to the method, however, it is not guaranteed that a user having purchased the apparatus operates a power switch to be a trigger for recording the date information by himself (herself). The reason is as follows. The power switch is often operated by a manufacturer or a distributor in order to confirm quality before a shipment. For this reason, if a consumer who tries to do something dishonest with a false purchasing date insists that the date information is not recorded as a using start date in the memory by his (her) own operation but is recorded by an action on a product supplier side before purchasing the product, it is very hard to reject the insistence in the technique disclosed in JP-A-2000-152287.

### BRIEF DESCRIPTION OF THE SEVERAL VIEWS OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 is a hardware block diagram showing an example of a configuration of an information processing apparatus according to an embodiment of the invention;

FIG. 2 is an exemplary block diagram showing a function related to a using start date record processing;

FIG. 3 is an exemplary diagram illustrating a software configuration and a hardware configuration which implement the function related to the using start date record processing; and

FIG. 4 is a flowchart showing an example of the using start date record processing.

### DETAILED DESCRIPTION

Various embodiments according to the present invention will be described hereinafter with reference to the accompanying drawings. In general, according to one embodiment of the present invention, there is provided an information processing apparatus including: a date generating module configured to generate date information in a real time; a nonvolatile recording module configured to record the date information in a given area; and a recording control module configured to access to the given area when specific software is started, wherein the recording control module is configured to record present date information generated by the date generating module in the given area when the date information is not recorded in the given area.

An embodiment of an information processing apparatus and a method of recording a using start date thereof according to the invention will be described with reference to the accompanying drawings.

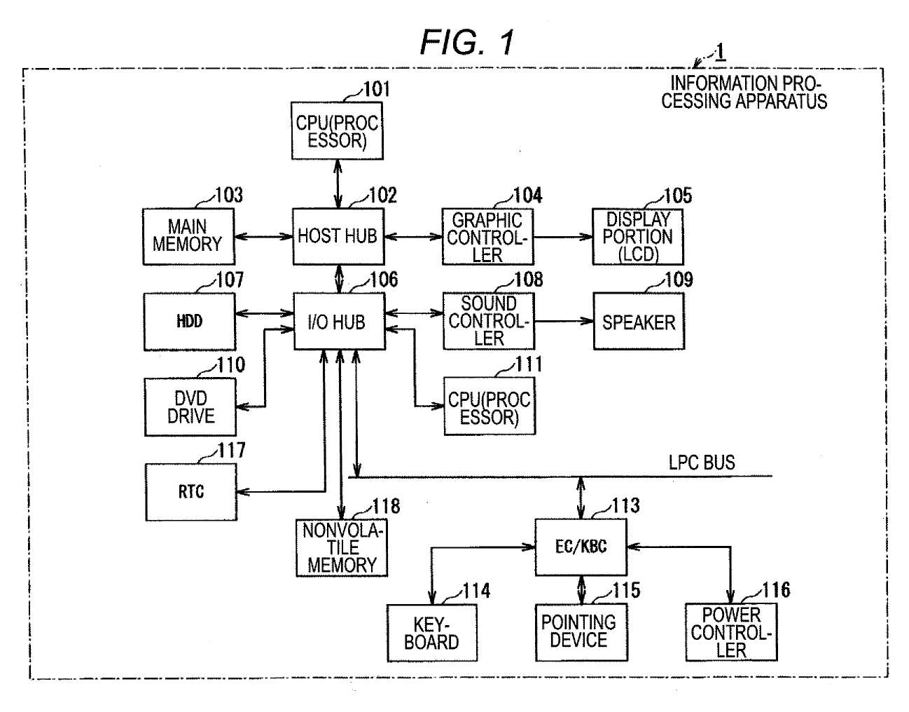

FIG. 1 is a hardware block diagram showing an example of a configuration of an information processing apparatus 1 according to an embodiment of the invention.

The information processing apparatus 1 is a personal computer, for example, and includes a CPU 101 for performing various information processing and controls according to a program. Various devices are connected to the CPU 101 through a host hub 102 and an I/O hub 106.

A main memory 103 and a graphic controller 104 which function as a working area for a program are connected to the host hub 102. A display portion 105 configured by a Liquid Crystal Display (LCD) is connected to the graphic controller 104. Various character information and image information are displayed on the display portion 105.

On the other hand, a Hard Disk Drive (HDD) 107, a DVD drive 110, a sound controller 108 and a BIOSROM 111 are connected to the I/O hub 106. An Operating System (OS) and various application software, and furthermore, various data are stored in the HDD 107. Moreover, a speaker 109 is connected to the sound controller 108. The BIOSROM 111 stores Basic Input/Output System (BIOS) to be run first when the information processing apparatus 1 is started.

In addition, various peripheral devices are connected to the I/O hub 106 through an internal bus such as a Low Pin Count (LPC) bus 112.

An Embedded Controller/Key Board Controller (EC/KBC) 113 which is an embedded processor is connected to the LPC bus 112, and a keyboard 114, a pointing device 115 such as a mouse and a power controller 116 are connected to the EC/KBC 113.

Moreover, a Real Time Clock (RTC) 117 and a nonvolatile memory 118 are also connected to the I/O hub 106. The RTC 117 generates time information (including date information) such as a present date and time in a real time and functions as a date information generating portion in the embodiment.

The RTC 117 is driven by a built-in battery (not shown). Even if a power supply of the information processing apparatus 1 is turned OFF, present time information is always generated continuously. The time information of the RTC 117 is completely initialized in a usual shipment. Also when a user purchases and first uses the information processing apparatus 1, accordingly, it is possible to acquire date information about a using start date from data output from the RTC 117 at that time without any special initializing operation.

The nonvolatile memory 118 is configured by a semiconductor nonvolatile memory such as a flash memory, and recorded contents are stored even if the power supply of the information processing apparatus 1 is turned OFF. In the embodiment, the nonvolatile memory 118 functions as a nonvolatile recording portion for recording the using start date.

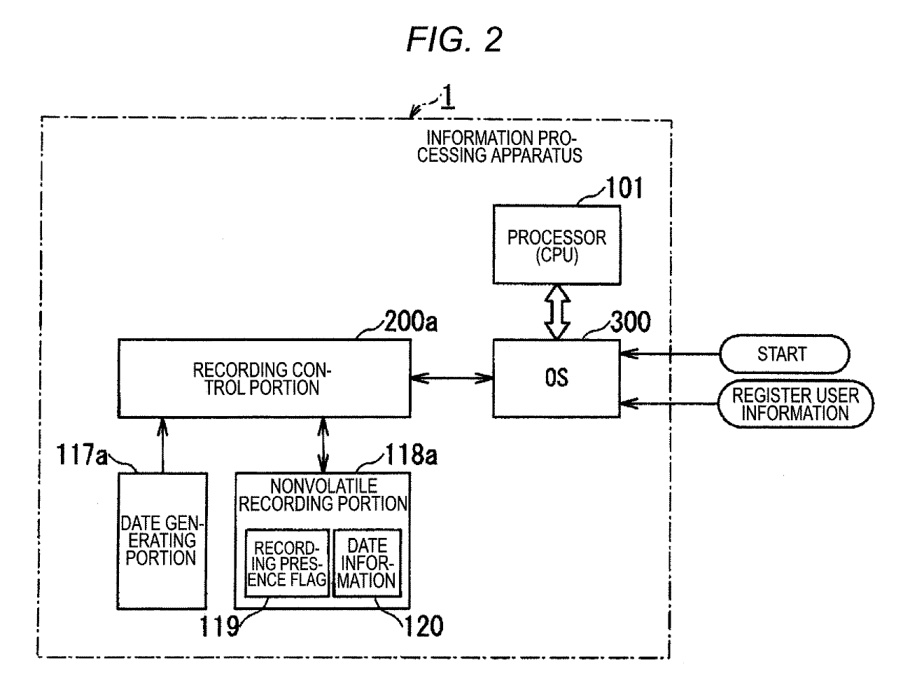

FIG. 2 is a functional block diagram showing a function of the information processing apparatus 1, particularly, a function related to a processing for recording a using start date.

The information processing apparatus 1 includes a date generating portion 117a for generating present date information in a real time and a nonvolatile recording portion 118a for recording the date information generated in the date generating portion 117a in a given area.

Moreover, the information processing apparatus 1 includes a recording control portion 200a and an OS 300 performed through the CPU (processor) 101. The recording control portion 200a gives access to a given area of the recording portion 118a and determines whether or not the date information has already been recorded in the recording portion 118a when specific software is started. If the date information is not recorded, the present date information generated by the date generating portion 117a is recorded in the recording portion 118a. For the specific software, it is preferable to use software which is incorporated in a setup sequence of the OS 300 (a sequence of a setup processing to be carried out when installing the OS 300 in the information processing apparatus 1) and is started when the setup sequence of the OS 300 is performed, for example. Software for an initial registration processing such as a user registration processing of the OS 300 corresponds to the specific software, for example.

FIG. 2 is a block diagram representing the function of the information processing apparatus 1. The recording control portion 200a and the date generating portion 117a can also be implemented in both hardware and software.

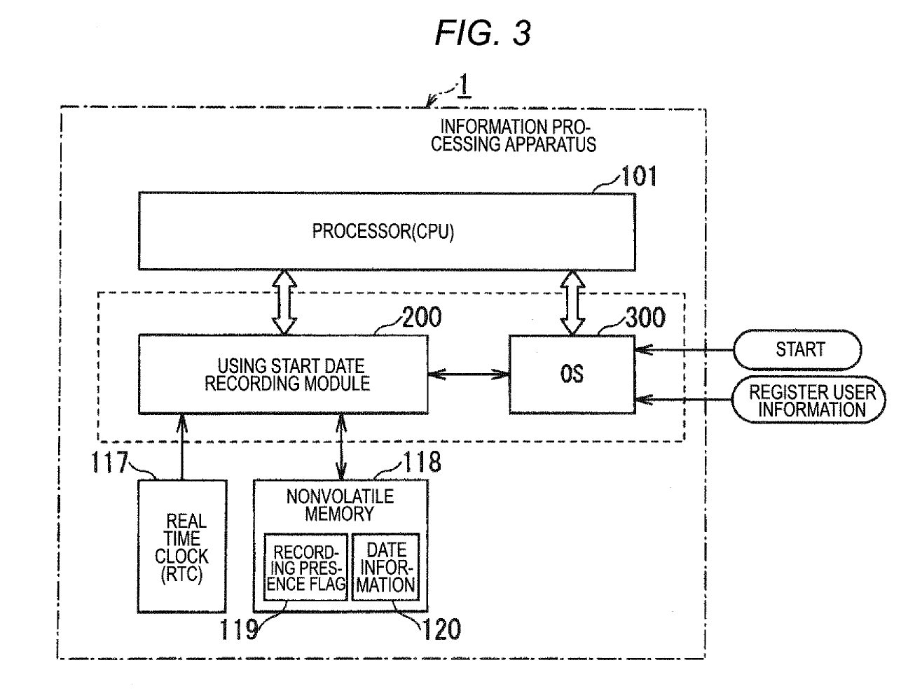

On the other hand, FIG. 3 is a block diagram showing means for implementing a using start date record processing in the information processing apparatus 1 more specifically.

The implementing means in FIG. 3 implements the function of the recording control portion 200a in software (a using start date recording module 200). Moreover, the function of the date generating portion 117a is implemented by the RTC 117 and the function of the nonvolatile recording portion 118a is implemented by the nonvolatile memory 118.

The using start date recording module 200 and the OS 300 are software stored in the HDD 107 (see FIG. 1), for example, and are performed by the CPU 101.

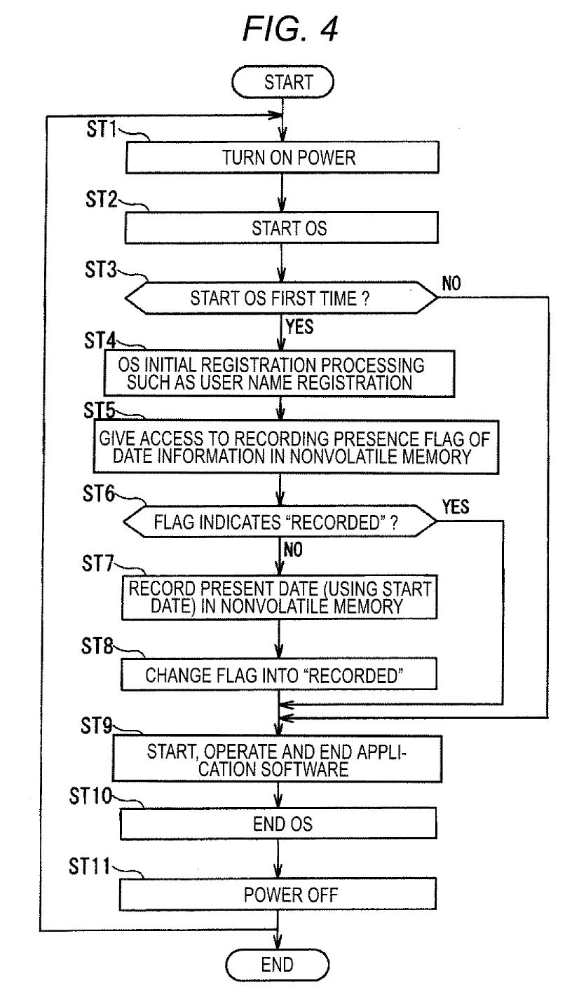

FIG. 4 is a flowchart showing an example of a processing in a method of recording a using start date of the information processing apparatus 1 according to the embodiment. With reference to FIG. 3, the method of recording a using start date will be specifically described below along the flowchart of FIG. 4.

When the power supply of the information processing apparatus 1 is turned ON (Step ST1), the BIOS is read from the BIOSROM 111 (see FIG. 1) so that the BIOS is started and the OS 300 is then started (Step ST2).

At Step ST3, it is determined whether the OS 300 is started for the first time or not. The case in which the OS 300 is started for the first time indicates the case in which a setup sequence is performed when the OS 300 is installed, for example.

If the OS 300 is not started for the first time, the processing proceeds to Step ST9 after the completion of the OS starting. A variety of application software are started depending on a selection by a user and an operation corresponding to each application software is carried out. After an end of the application software, a processing for ending the OS 300 (Step ST10) is performed and the power supply of the information processing apparatus 1 is turned OFF.

On the other hand, if it is determined that the OS 300 is started for the first time, an initial registration processing of the OS 300 (Step ST4) is performed as a processing in a starting sequence of the OS 300. The initial registration processing of the OS 300 includes a user name registration processing, for example.

In the information processing apparatus 1 according to the embodiment, more specifically, the using start date recording module 200 is started in the middle of the initial registration processing of the OS 300 or when the initial registration processing is completed in the setup sequence of the OS 300. Processing from the Steps ST5 to ST8 are performed by the using start date recording module 200.

First of all, the nonvolatile memory 118 is accessed at the Step ST5. As described above, the nonvolatile memory 118 is a nonvolatile semiconductor memory such as a flash memory. The nonvolatile memory 118 is provided with a flag recording area 119 for recording a flag indicative of the presence of record of date information and a date information recording area 120 for recording the date information. At the Step ST5, the flag recording area 119 is accessed for confirmation of a state of the flag.

If the flag indicates “recorded” (Yes in Step ST6), the date information is not recorded in the date information recording area 120 but the processing proceeds to the Step ST9, and a normal application software start processing is performed.

On the other hand, if the flag indicates “not recorded” (No in Step ST6), present date information is acquired from the RTC 117 and the date information thus acquired is recorded as a using start date for the information processing apparatus 1 in the date information recording area 120 of the nonvolatile memory 118 (Step ST7). Then, the flag of the flag recording area 119 is changed from “not recorded” to “recorded” (Step ST8) and the processing proceeds to the Step ST9.

The nonvolatile memory 118 is accessed without a special operation by the user, and the using start date is recorded irrespective of the user's intention. Moreover, the nonvolatile memory 118 has such a configuration that rewrite cannot be carried out by the operation of the user, and the user cannot freely change the using start date which is once recorded.

Furthermore, the nonvolatile memory 118 has such a configuration that the recorded using start date can be neither read nor displayed by the operation of the user. Usually, the recorded using start date can be read only using a dedicated reading tool provided by a product supply side such as a manufacturer or a distributor.

In the processing from the Steps ST3 to ST8, date information (that is, a using start date) on only a date that the user first uses the information processing apparatus 1 after purchasing it and is recorded in the nonvolatile memory 118, and a change in the using start date which is once recorded is prohibited even if the power supply is then turned ON/OFF many times.

In a shipment of the information processing apparatus if the flag recording area 119 of the nonvolatile memory 118 is set to be “not recorded” and nothing is recorded in the date information recording area 120.

On the other hand, while the nonvolatile memory 118 is accessed through the using start date recording nodule 200, the using start date recording module 200 is started in the middle of the initial registration processing of the OS 300 or after the completion of the initial registration processing.

Before the shipment of the information processing apparatus 1, a power distribution may be performed on the supplier side such as a manufacturer or a distributor in order to confirm quality thereof. However, the initial registration processing such as a user name registration is performed only after the information processing apparatus 1 is possessed by the user.

JP-A-152287 discloses the technique for recording the using start date in the memory by the operation of the power switch. In some cases, however, the operation of the power switch is carried out by the manufacturer or the distributor in order that the quality is confirmed before the shipment. In the case in which a consumer who tries to do something dishonest with a false purchasing date insists that the date information is not recorded as a using start date in the memory by his (her) own action but is recorded by an action on a product supplier side before purchasing, accordingly, it is very hard to reject the insistence in the technique disclosed in JP-A-152287.

On the other hands in the information processing apparatus 1 according to the embodiment, the using start date is recorded in the setup sequence of the software (OS 300) in place of the operation of the power switch by setting, as a trigger, the processing to be performed only after the information processing apparatus 1 is possessed by the user (the initial registration processing such as the user name registration). For this reason, it is possible to eliminate the wrongful insistence of the consumer.

Moreover, the using start date is not recorded in a recording medium which can be initialized by the user operation, for example, the HDD 107 but the nonvolatile memory 118 having such a configuration that the user cannot carry out rewrite. Therefore, it is also impossible to intentionally delete the using start date which is recorded.

The initial registration processing such as the user name registration can be repetitively performed many times for the purchased information processing apparatus 1 by installing a new OS or reinstalling the OS 300. In the case in which the using start date is recorded, however, there is performed a processing for changing the flag from “not recorded” to “recorded” and then skipping a record of a date (that is, a change of a date). Even if the new OS is installed or the OS is reinstalled, therefore, the recorded using start date is not changed.

As described above, according to the information processing apparatus 1 and the method of recording a using start date thereof according to the embodiment, it is possible to automatically record the using start date of the apparatus without performing an extra operation and to reliably guarantee that the using start date is recorded on a date that the apparatus is first used after purchasing. Moreover, the user cannot change the using start date which is once recorded.

As a result, the product supplier side can avoid a friction with a consumer about a term of guarantee of a product. Also in the case in which the consumer loses a certificate for a selling date, moreover, it is possible to objectively prove the using start date by reading the recorded using start date data through a dedicated reading tool on the supplier side. Therefore, a profit is also given to the consumer side.

The invention is not exactly restricted to the embodiment but components can be deformed and materialized without departing from the scope thereof in an implementation phase. Moreover, various inventions can be formed by a proper combination of the components disclosed in the embodiment. For example, some of all the components described in the embodiment may be deleted. Furthermore, it is also possible to properly combine components in different embodiments.

What is claimed is:

1. An information processing apparatus comprising:
a date generating module configured to generate date information in a real time;
a nonvolatile recording module configured to record the date information in a given area; and
a recording control module configured to access to the given area when specific software is started,
wherein the recording control module is configured to record present date information generated by the date generating module in the given area when the date information is not recorded in the given area.

2. The apparatus of claim 1, wherein:
the specific software includes a program to be incorporated in a setup sequence of an operating system; and
the recording control module is configured to access to the given area when a processing for registering user information is performed in the setup sequence.

3. The apparatus of claim 1, wherein:
the recording module has a flag recording area for recording a flag and a date information recording area for recording the date information, the flag representing whether the date information is recorded or not;
the recording control module is configured to access the flag recording area to determine whether the date information is recorded or not based on the flag; and
the recording control nodule is configured to record the present date information in the date recording area and to record the flag representing that the date information is recorded when the date information is not recorded.

4. The apparatus of claim 1, wherein the nonvolatile recording module is configured by an unrewritable semiconductor nonvolatile memory.

5. The apparatus of claim 1, wherein the nonvolatile recording module is configured to allow recorded date information to be read only by a dedicated reading tool.

6. An information processing apparatus comprising:
a processor;
a real time clock configured to generate date information in a real time; and
a nonvolatile memory configured to record the date information in a given area,
wherein the processor performing at least:
an operating system process;
a using start date recording module process to access to the given area when a setup sequence of the operating system is performed and to record present date information generated by the real time clock when the date information is not recorded in the given area.

7. The apparatus of claim 6, wherein the processor is configured to access the given area when a processing for registering user information is performed in the setup sequence.

8. The apparatus of claim 6, wherein:
the nonvolatile memory is configured to include a flag recording area for recording a flag and a date information recording area for recording the date information, the flag representing whether the date information is recorded or not the processor is configured to access the flag recording area to determine whether the date information is recorded or not based on the flag; and
the processor is configured to record the present date information in the date recording area and to record the flag representing that the date information is recorded when the date information is not recorded.

9. The apparatus of claim 6, wherein the nonvolatile memory is configured by an unrewritable semiconductor nonvolatile memory.

10. The apparatus of claim 6, wherein the nonvolatile memory is configured to allow recorded date information to be read only by a dedicated reading tool.

11. A method of recording a using start date of an information processing apparatus, the information processing apparatus comprising a nonvolatile memory having a given area, the method comprising:
generating date information in a real time;
accessing the given area when specific software is started; and
recording generated present date information when the date information is not recorded in the given area.

12. The method of claim 11, wherein:
the specific software includes a program to be incorporated in a setup sequence of an operating system installed in the information processing apparatus, and
the accessing step includes accessing the given area when a processing for registering user information is performed in the setup sequence.

13. The method of claim 11, wherein:
the nonvolatile memory is configured to include a flag recording area for recording a flag and a date information recording area for recording the date information, the flag representing whether the date information is recorded or not;
the accessing step includes accessing the flag recording area to determine whether the date information is recorded or not based on the flag; and
the recording step includes recording the present date information in the date recording area and recording the flag representing that the date information is recorded when the date information is not recorded.

14. The method of claim 11, wherein the nonvolatile memory is configured by an unrewritable semiconductor nonvolatile memory.

15. The method of claim 11, wherein the nonvolatile memory is configured to allow recorded date information to be read only by a dedicated reading tool.
